(19) United States
(12) Patent Application Publication
(10) Pub. No.: US 2025/0306922 A1
(43) Pub. Date: Oct. 2, 2025

(54) METHOD FOR PROCESSING DATA USING ADDER AND ELECTRONIC DEVICE

(71) Applicant: Shenzhen Corerain Technologies Co., Ltd., Shenzhen (CN)

(72) Inventors: Chenchen LU, Shenzhen (CN); Kuen Hung TSOI, Shenzhen (CN); Xinyu NIU, Shenzhen (CN)

(73) Assignee: Shenzhen Corerain Technologies Co., Ltd., Shenzhen (CN)

(21) Appl. No.: 19/090,575

(22) Filed: Mar. 26, 2025

(30) Foreign Application Priority Data
Mar. 26, 2024 (CN) 202410355471.8

(51) Int. Cl. G06F 9/30; G06F 7/53

(52) U.S. Cl. CPC G06F 9/3001; G06F 7/5318; G06F 9/30029

(57) ABSTRACT

A method for processing data using an adder, an electronic device and a non-transitory computer-readable storage medium. The adder includes a first preprocessing unit and an encoding unit. The method includes: preprocessing first data to obtain a first preprocessing result corresponding to the first data by the first preprocessing unit in response to a summation instruction for the first data; and outputting a first encoded value to the encoding unit from the first preprocessing unit based on characteristics of the first data; where preprocessing the first data by the first preprocessing unit includes performing a NOT operation on the first data or outputting the first data directly; and the first encoded value is 0 or 1. According to the embodiments, the “add 1” operations for all data are processed in a centralized manner by the encoding unit, thereby streamlining the circuit structure and saving circuit resources.

### TECHNICAL FIELD

The invention relates to the field of circuits, in particular to a method for processing data using an adder, an electronic device and a non-transitory computer-readable storage medium.

### BACKGROUND

With the development of artificial intelligence (AI) technology, AI algorithms are becoming increasingly complex. These algorithms often involve a large number of multiplications, additions, and accumulations, and require handling growing amounts of data. Furthermore, there is a demand for computation time to be minimized. Therefore, the requirements for the computational power of computers or processors are rising.

In the prior art, to enhance the computational power of processors, parallel computing is typically adopted. This involves splitting computational tasks across multiple multipliers and adders to execute the tasks in parallel, rather than having a single or a few multipliers and adders handle multiple computations in sequence. Once the calculations are finished, the results are combined together.

For adders, common parallel processing methods include the adder chain shown in FIG. 1a and the adder tree depicted in FIG. 1b. As illustrated in FIGS. 1a and 1b, by using three adders, it is possible to compute the addition of four data points in parallel at any given moment.

For the adder shown in FIG. 1a or 1b, when performing addition or subtraction operations on multiple data points, or when the data is represented in binary sign-magnitude form rather than two's complement form, it is necessary to first convert the data intended for subtraction or the negative numbers in sign-magnitude form to their two's complement representation based on an adder chain or adder tree. That is, A minus B is equivalent to A plus the two's complement of B. Negative numbers represented in binary sign-magnitude form need to be converted to two's complement before performing addition or subtraction operations. For example, to find the two's complement of B, invert all the bits of B and then add 1. This allows the adder shown in FIG. 1a or 1b to be transformed into the adder shown in FIG. 2a or 2b, respectively. As shown in FIG. 2a or 2b, when subtracting one or more data points from a sum of multiple data points, the data to be subtracted first passes through a complementation unit before being added; otherwise, the data is sent directly to the adder without passing through the complementation unit.

Although the adder chain and adder tree circuits have been enhanced with the complement operation, allowing them to perform addition or subtraction operations on multiple data points or on sign-magnitude data, the process of adding 1 during the complement calculation requires the inclusion of a multi-bit adder circuit, even if the data consists of only a single bit. This significantly increases the resource consumption of the entire circuit.

### SUMMARY

The invention proposes a method for processing data using an adder, an electronic device and a non-transitory computer-readable storage medium, to address the issue of high circuit resource consumption associated with current adders.

In a first aspect of the invention, a method for processing data using an adder is provided. The adder comprises a first preprocessing unit and an encoding unit. The method comprises: preprocessing first data to obtain a first preprocessing result corresponding to the first data by the first preprocessing unit in response to a summation instruction for the first data; and outputting a first encoded value to the encoding unit from the first preprocessing unit based on characteristics of the first data; wherein preprocessing the first data by the first preprocessing unit, comprises performing a NOT operation on the first data or outputting the first data directly; and the first encoded value is 0 or 1.

According to some embodiments, the adder further comprises a second preprocessing unit, and the method further comprises: preprocessing second data to obtain a second preprocessing result corresponding to the second data by the second preprocessing unit in response to a summation instruction for the second data; and outputting a second encoded value to the encoding unit from the second preprocessing unit based on characteristics of the second data.

According to some embodiments, the adder further comprises outputting the first encoded value and the second encoded value to the summation unit from the encoding unit; and summing the first preprocessing result, the second preprocessing result, the first encoded value and the second encoded value by the summation unit.

According to some embodiments, the adder further comprises a summation unit, and the method further comprises: summing the first encoded value and the second encoded value by the encoding unit to obtain an encoded sum, and sending the encoded sum to the summation unit; and summing the first preprocessing result, the second preprocessing result and the encoded sum by the summation unit.

According to some embodiments, outputting a first encoded value to the encoding unit from the first preprocessing unit based on characteristics of the first data comprises: outputting the first encoded value being 1 to the encoding unit from the first preprocessing unit in response to the first data being stored in two's complement and a subtraction operation being performed on the first data; and; and outputting the first encoded value being 0 to the encoding unit from the first preprocessing unit in response to the first data being stored in two's complement and an addition operation being performed on the first data.

According to some embodiments, outputting, a first encoded value to the encoding unit from the first preprocessing unit based on characteristics of the first data comprises: the first encoded value being 1 to the encoding unit from the first preprocessing unit in response to the first data being stored in sign-magnitude form as a positive number and a subtraction operation being performed on the first data; outputting the first encoded value being 0 to the encoding unit from the first preprocessing unit in response to the first data being stored in sign-magnitude form as a positive number and an addition operation being performed on the first data; outputting the first encoded value being 1 to the encoding unit from the first preprocessing unit in response to the first data being stored in sign-magnitude form as a negative number and an addition operation being performed on the first data; and outputting the first encoded value being 0 to the encoding unit from the first preprocessing unit in response to the first data being stored in sign-magnitude form as a negative number and a subtraction operation being performed on the first data.

According to some embodiments, preprocessing the first data by the first preprocessing unit comprises: performing a NOT operation on the first data by the first preprocessing unit, in response to the first data being stored in two's complement and a subtraction operation being performed on the first data, the first data being stored in sign-magnitude form as a positive number and a subtraction operation being performed on the first data, or the first data being stored in sign-magnitude form as a negative number and an addition operation being performed on the first data; and otherwise, outputting the first data by the first preprocessing unit directly.

According to some embodiments, the summation unit comprises a Wallace adder tree unit.

According to an aspect of the invention, an electronic device is provided, comprising a processor; and a memory storing a computer program which, when executed by the processor, causes the processor to implement the method according to any of the aforementioned embodiments.

According to an aspect of the invention, a non-transitory computer-readable storage medium is provided, having stored thereon computer-readable instructions which, when executed by a processor, cause the processor to implement the method according to any of the aforementioned embodiments.

According to the embodiments of the invention, the “add 1” operation in the summation data is output through the encoding unit, allowing the “add 1” operations for all summation data to be processed in a centralized manner by the encoding unit during the addition of multiple data points, thereby achieving a streamlined circuit.

According to other embodiments, all summation data shares the same encoding unit. During data summation, the input of 0 or 1 to the encoding unit is determined based on the storage method of the summation data, and the “add 1” operations for all data are processed in a centralized manner by the encoding unit, thereby conserving circuit resources and achieving a streamlined circuit.

It should be understood that the above general description and the following detailed description are only exemplary, and do not limit the present invention.

### BRIEF DESCRIPTION OF THE DRAWINGS

In order to more clearly explain the technical schemes of the embodiments of the invention, the drawings needed in the description of the embodiments are briefly set forth below. The above and other objects, features and advantages of the invention will become more apparent by describing in detail exemplary embodiments with reference to the accompanying drawings.

FIG. 1a is a schematic diagram of an adder chain structure in the prior art.

FIG. 1b is a schematic diagram of an adder tree structure in the prior art.

FIG. 2a is a schematic diagram of an adder chain incorporating a complement operation in the prior art.

FIG. 2b is a schematic diagram of an adder tree incorporating a complement operation in the prior art.

FIG. 3 is a schematic diagram of a method for processing data using an adder according to an exemplary embodiment of the invention.

FIG. 4 illustrates an example of complementing data to be summed according to an exemplary embodiment of the invention.

FIG. 5 illustrates another example of complementing data to be summed according to an exemplary embodiment of the invention.

FIG. 6 is a schematic diagram of processing data using an adder according to an exemplary embodiment of the invention.

FIG. 7 is a schematic diagram of another method for processing data using an adder according to an exemplary embodiment of the invention.

FIG. 8 is a schematic diagram of another method for processing data using an adder according to an exemplary embodiment of the invention.

FIG. 9 is a schematic diagram of processing data using a Wallace adder tree according to an exemplary embodiment of the invention.

FIG. 10 is a schematic diagram of an electronic device according to an exemplary embodiment of the invention.

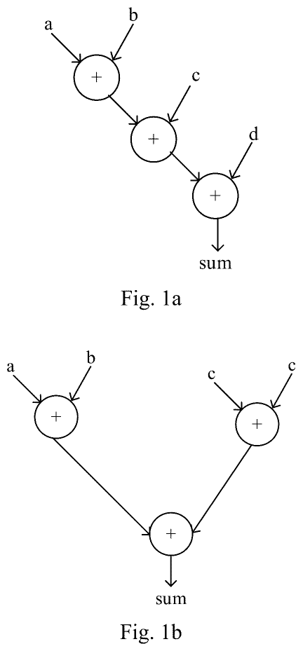

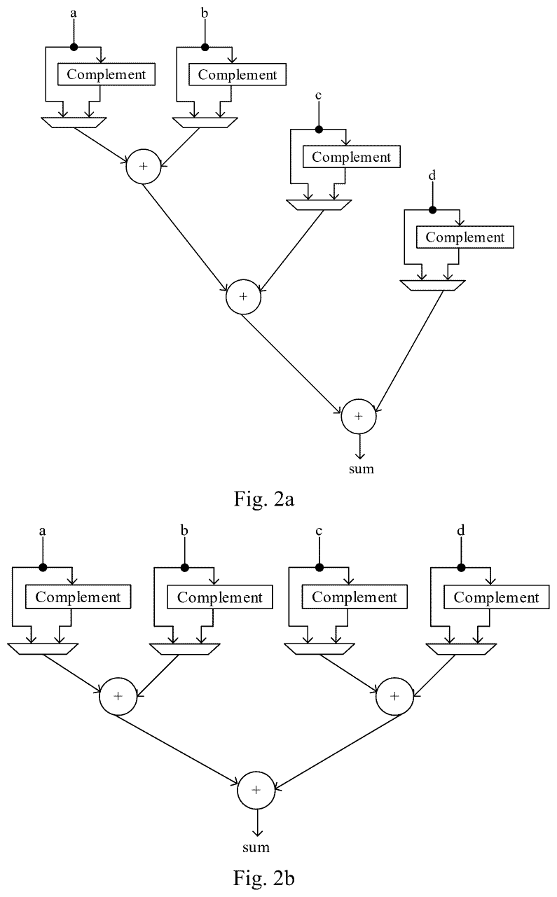

### DETAILED DESCRIPTION OF EMBODIMENTS

Exemplary embodiments will be described more fully below with reference to the accompanying drawings. However, the exemplary embodiments can be implemented in various forms and should not be construed as limited to the embodiments set forth herein. These embodiments are provided to make the invention more thorough and complete, and to fully convey the concept of the exemplary embodiments to those skilled in the art. In the drawings, the same reference numerals refer to the same or similar parts, so repeated descriptions will be omitted.

The described features, structures, or characteristics may be combined in any suitable manner in one or more embodiments. In the following description, numerous specific details are provided to give a thorough understanding of the embodiments of the disclosure. However, those skilled in the art will realize that the technical solution of the disclosure can be practiced without one or more of these specific details, or other ways, components, materials, devices or operations can be adopted. In these cases, well-known structures, methods, devices, implementations, materials or operations will not be shown or described in detail.

The flowchart shown in the drawings is only an exemplary illustration, and does not necessarily include all contents and operations/steps, nor does it have to be executed in the described order. For example, some operations/steps can be decomposed, while others can be merged or partially merged, so the actual execution order may change according to the actual situation.

Terms such as “first” and “second” in the specification and claims of the invention and the drawings are used to distinguish different objects, but not to describe a specific order. Further, the terms “comprise” and “have” and any variations therefor are intended to cover non-exclusive inclusion. For example, a process, method, system, product or device comprising a series of steps or units is not limited to the listed steps or units, but optionally comprises steps or units not listed, or optionally comprises other steps or units inherent to the process, method, product or device.

Specific embodiments of the invention will be described in detail below with reference to the accompanying drawings.

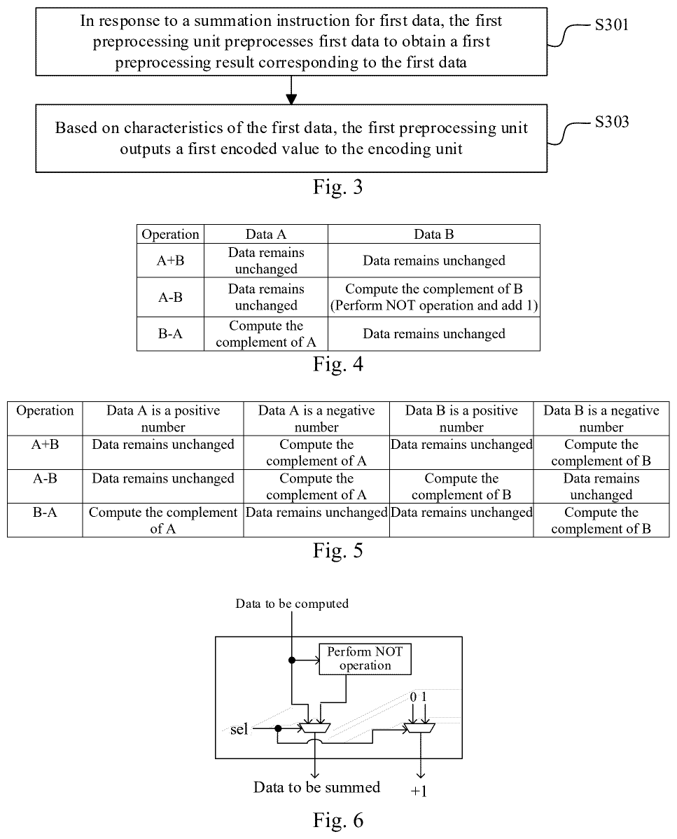

FIG. 3 is a schematic diagram of a method for processing data using an adder according to an exemplary embodiment of the invention. The method shown in FIG. 3 comprises steps S301 and S303.

According to the embodiments of the invention, the adder shown in FIG. 3 comprises a first preprocessing unit and an encoding unit.

As shown in FIG. 3, in S301, in response to a summation instruction for first data, the first preprocessing unit preprocesses first data to obtain a first preprocessing result corresponding to the first data.

According to the embodiments of the invention, in response to the first data being stored in two's complement and a subtraction operation being performed on the first data, or in response to the first data being stored in sign-magnitude form as a positive number and a subtraction operation being performed on the first data, or in response to the first data being stored in sign-magnitude form as a negative number and an addition operation being performed on the first data, the first preprocessing unit performs a NOT operation on the first data; otherwise, the first preprocessing unit outputs the first data directly.

In S303, based on the characteristics of the first data, the first preprocessing unit outputs a first encoded value to the encoding unit.

According to the embodiments of the invention, in response to the first data being stored in two's complement and a subtraction operation being performed on the first data, the first encoded value is 1. In response to the first data being stored in two's complement and an addition operation being performed on the first data, the first encoded value is 0.

For example, as shown in FIG. 4, in response to the first data being stored in two's complement and a subtraction operation being performed on the first data, it is necessary to perform a complement operation on the first data in the prior art. According to the embodiments of the invention, to eliminate the complement operation on the first data, the first encoded value is set to 1.

For another example, as shown in FIG. 4, in response to the first data being stored in two's complement and an addition operation being performed on the first data, the first data does not need to be processed, and the first encoded value is 0.

According to the embodiments of the invention, in response to the first data being stored in sign-magnitude form as a positive number and a subtraction operation being performed on the first data, the first encoded value is 1. In response to the first data being stored in sign-magnitude form as a positive number and an addition operation being performed on the first data, the first encoded value is 0. In response to the first data being stored in sign-magnitude form as a negative number and an addition operation being performed on the first data, the first encoded value is 1. In response to the first data being stored in sign-magnitude form as a negative number and a subtraction operation being performed on the first data, the first encoded value is 0.

For example, as shown in FIG. 5, in response to the first data being stored in sign-magnitude form as a positive number and a subtraction operation being performed on the first data, it is necessary to perform a complement operation on the first data in the prior art. According to the embodiments of the invention, to eliminate the complement operation on the first data, the first encoded value is set to 1.

For another example, as shown in FIG. 5, in response to the first data being stored in sign-magnitude form as a negative number and an addition operation being performed on the first data, it is necessary to perform a complement operation on the first data in the prior art. According to the embodiments of the invention, to eliminate the complement operation on the first data, the first encoded value is set to 1.

For another example, in response to the first data being stored in sign-magnitude form as a positive number and an addition operation being performed on the first data, the first data does not need to be processed, and the first encoded value is 0.

For another example, in response to the first data being stored in sign-magnitude form as a negative number and a subtraction operation being performed on the first data, the first data does not need to be processed, and the first encoded value is 0.

According to the embodiment shown in FIG. 3, when the first encoded value is 1, the first preprocessing unit performs a NOT operation on the first data; otherwise, the first preprocessing unit outputs the first data directly. This approach splits the complement operation into a NOT operation and addition of 1, and the “add 1” operations for all data are processed in a centralized manner by the encoding unit. This replaces multi-bit adders in multiple complement operations, thereby streamlining the circuit structure and conserving circuit resources.

FIG. 6 is a schematic diagram of processing data using an adder according to an exemplary embodiment of the invention. As shown in FIG. 6, according to the method depicted in FIG. 3, the value of a sel signal is determined based on the storage method of the data to be computed. If the sel signal is 1, a left selector directly outputs the data to be computed to a “data to be summed” signal, while a right selector outputs 0 to a “+1” signal. If the sel signal is 0, the left selector performs a NOT operation on the data to be computed before outputting it to the “data to be summed” signal, and the right selector outputs 1 to the “+1” signal.

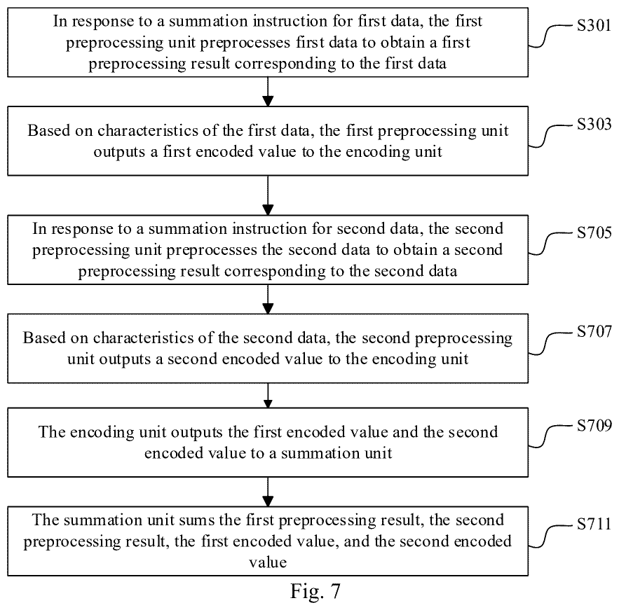

FIG. 7 is a schematic diagram of another method for processing data using an adder according to an exemplary embodiment of the invention. As shown in FIG. 7, the method illustrated in FIG. 3 comprises not only steps S301 and S303 but also steps S705, S707, S709, and S711. For brevity, the following will only describe the differences between the embodiment shown in FIG. 7 and that in FIG. 3, without going into detail about their common aspects.

In S705, in response to a summation instruction for second data, the second preprocessing unit preprocesses the second data to obtain a second preprocessing result corresponding to the second data.

As the procedure for obtaining the second preprocessing result in S705 is the same as that in S301, no further explanation will be provided here.

In S707, based on characteristics of the second data, the second preprocessing unit outputs a second encoded value to the encoding unit.

As the procedure for outputting the second encoded value in S707 is the same as that in S303, no further explanation will be provided here.

In S709, the encoding unit outputs the first encoded value and the second encoded value to a summation unit.

In S709, the encoding unit does not process the first encoded value and the second encoded value but directly outputs them instead.

In S711, the summation unit sums the first preprocessing result, the second preprocessing result, the first encoded value, and the second encoded value.

According to the embodiment shown in FIG. 7, when the number of data points to be computed exceeds two, the data requiring complement operations is split into a

NOT operation and addition of 1. The encoding unit then centralizes the “add 1” operations for all data and outputs them to the summation unit. This replaces multi-bit adders in multiple complement operations, thereby streamlining the circuit structure and conserving circuit resources.

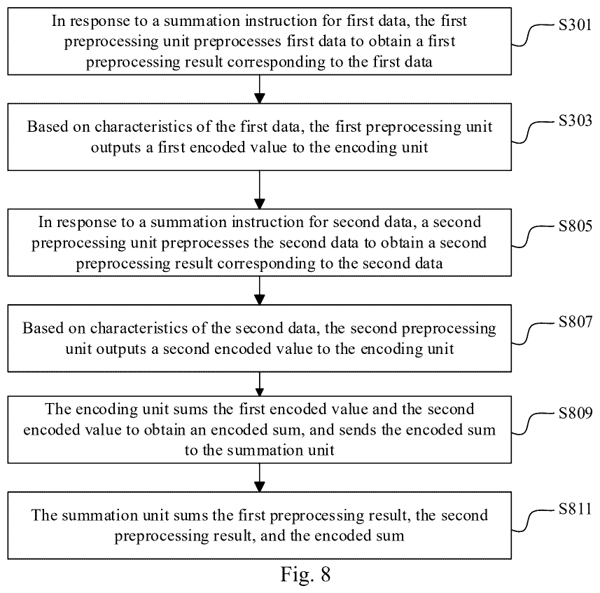

FIG. 8 is a schematic diagram of another method for processing data using an adder according to an exemplary embodiment of the invention. As shown in FIG. 8, the method illustrated in FIG. 3 comprises not only steps S301 and S303 but also steps S805, S807, S809, and S811. For brevity, the following will only describe the differences between the embodiment shown in FIG. 8 and that in FIG. 3, without going into detail about their common aspects.

In S805, in response to a summation instruction for second data, a second preprocessing unit preprocesses the second data to obtain a second preprocessing result corresponding to the second data.

As the procedure for obtaining the second preprocessing result in S805 is the same as that in S301, no further explanation will be provided here.

In S807, based on characteristics of the second data, the second preprocessing unit outputs a second encoded value to the encoding unit.

As the procedure for outputting the second encoded value in S807 is the same as that in S303, no further explanation will be provided here.

In S809, the encoding unit sums the first encoded value and the second encoded value to obtain an encoded sum, and sends the encoded sum to the summation unit.

In S809, the encoding unit sums the first encoded value and the second encoded value before outputting the result to the summation unit.

In S811, the summation unit sums the first preprocessing result, the second preprocessing result, and the encoded sum.

According to the embodiment shown in FIG. 8, when the number of data points to be computed exceeds two, the data requiring complement operations is split into a NOT operation and addition of 1. The encoding unit then sums the “add 1” operations for all data before outputting the result to the summation unit. This replaces multi-bit adders in multiple complement operations, thereby streamlining the circuit structure and conserving circuit resources.

According to the embodiments of the invention, the summation unit in FIG. 7 or 8 comprises a Wallace adder tree unit.

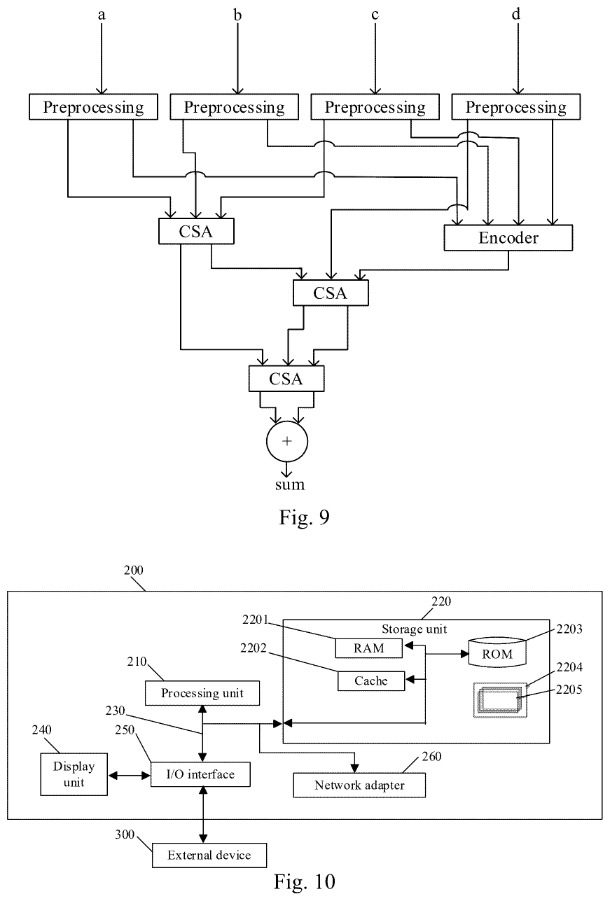

FIG. 9 is a schematic diagram of processing data using a Wallace adder tree according to an exemplary embodiment of the invention. As shown in FIG. 9, when the number of data points to be computed exceeds two, a Wallace adder tree replaces a conventional adder, further streamlining the circuit.

In FIG. 9, a, b, c, and d represent the data to be summed. Each preprocessing model determines whether the output of an encoder is 0 or 1 based on the method illustrated in FIG. 3. Further, each preprocessing module decides whether to perform a NOT operation on the data to be summed based on the characteristics of the data to be summed, and outputs the results to a carry save adder (CSA) of the Wallace adder tree.

According to some embodiments, the preprocessing model outputs the corresponding encoded values of the preprocessed data to be summed, such as 0 or 1, to the encoder. The encoder then calculates the sum of all encoded values corresponding to the data to be summed and outputs the result to the CSA of the Wallace adder tree.

As shown in FIG. 9, four data points to be computed can complete either the addition or subtraction of sign-magnitude numbers, or the addition or subtraction of two's complement numbers using three levels of CSA and one level of conventional adder, thereby streamlining the circuit structure and conserving circuit resources.

FIG. 10 is a schematic diagram of an electronic device according to an exemplary embodiment of the invention. An electronic device 200 according to this embodiment of the invention will be described below with reference to FIG. 10. The electronic device 200 shown in FIG. 10 is only an example, and should not impose any restrictions on the functions and application scope of the embodiment of the invention.

As shown in FIG. 10, the electronic device 200 is represented in the form of a general-purpose computing device. Components of the electronic device 200 may include, but are not limited to, at least one processing unit 210, at least one storage unit 220, a bus 230 connecting different system components (including the storage unit 220 and the processing unit 210), a display unit 240, etc.

The storage unit stores a program code, and the program code can be executed by the processing unit 210, so that the processing unit 210 performs the methods described in this specification according to various exemplary embodiments of the invention. For example, the processing unit 210 may implement the method according to any of the aforementioned embodiments.

The storage unit 220 may comprise a readable medium in the form of a volatile storage unit, such as a random access memory (RAM) 2201 and/or a cache storage unit 2202, and may further comprise a read-only memory (ROM) 2203.

The storage unit 220 may also comprise a program/utility tool 2204 with a group of (at least one) program modules 2205, such program modules 2205 include but are not limited to: an operation system, one or more application programs, other program modules and program data, and each or some combination of these examples may include the implementation of a network environment.

The bus 230 may represent or more of several types of bus structures, including memory cell bus or memory cell controller, peripheral bus, graphics acceleration port, processing unit or local bus using any of a variety of bus structures.

The electronic device 200 can also communicate with one or more external devices 300 (e.g., keyboard, pointing device, Bluetooth device, etc.), with one or more devices that enable users to interact with the electronic device 200, and/or with any device that enables the electronic device 200 to communicate with one or more other computing devices (e.g., routers, modems, etc.). This communication can be performed through an input/output (I/O) interface 250. Further, the electronic device 200 can also communicate with one or more networks (such as a local area network (LAN), a wide area network (WAN) and/or a public network, such as the Internet) through a network adapter 260. The network adapter 260 can communicate with other modules of the electronic device 200 through a bus 230. It should be understood that although not shown in the figure, other hardware and/or software modules can be used in conjunction with the electronic device 200, including but not limited to microcodes, device drivers, redundant processing units, external disk drive arrays, RAID systems, tape drives, data backup storage systems, etc.

Through the description of the above embodiments, it is easy for those skilled in the art to understand that the exemplary embodiments described here can be realized by software or by combining software with necessary hardware. The technical solutions according to the embodiments of the invention may be embodied in the form of a software product, which may be stored in a non-volatile storage medium (which may be a CD-ROM, USB flash drive, mobile hard drive, etc.) or on a network, and may include several instructions to enable a computing device (which may be a personal computer, server, or network device, etc.) to execute the method according to the embodiments of the invention.

A software product can adopt any combination of one or more readable media. The readable medium may be a readable signal medium or a readable storage medium. The readable storage medium can be, for example, but is not limited to, an electrical, magnetic, optical, electromagnetic, infrared, or semiconductor system, apparatus or device, or a combination of any of the above. More specific examples (a non-exhaustive list) of readable storage media include: electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The computer-readable storage medium may be a data signal propagated in a baseband or as part of a carrier wave, in which a readable program code is contained. This propagated data signal can take many forms, including but not limited to electromagnetic signal, optical signal or any suitable combination of the above. The readable storage medium may also be any readable medium other than the readable storage medium, which can send, propagate or transmit a program for use by or in combination with an instruction execution system, apparatus or device. The program code contained in the readable storage medium can be transmitted by any suitable medium, including but not limited to Wi-Fi, wire, optical cable, RF, etc., or any suitable combination of the above.

Computer program codes for performing the operations of the invention can be written by a combination of one or more programming languages, including object-oriented programming languages such as Java, C++, and conventional procedural programming languages such as “C” language or similar programming languages. The program code can be completely executed on user computing equipment, partially executed on user equipment, executed as an independent software package, partially executed on user computing equipment and partially executed on remote computing equipment, or completely executed on remote computing equipment or a server. In a case involving remote computing equipment, the remote computing equipment may be connected to user computing equipment through any kind of network including a local area network (LAN) or a wide area network (WAN), or may be connected to external computing equipment (e.g., connected through the Internet using an Internet service provider).

The said computer-readable medium carries one or more programs, which, when executed by the said equipment, cause the computer-readable medium to realize the aforementioned functions.

Those skilled in the art can understand that the above modules can be distributed in devices according to the description of the embodiment, or can be uniquely arranged in one or more devices of this embodiment with corresponding changes. The modules in the above embodiments can be merged into one module or further split into multiple submodules.

According to an embodiment of the invention, a computer program product is provided, comprising computer programs or instructions, and the computer programs or instructions, when executed by a processor, may implement the above method.

The embodiments of the invention have been introduced in detail above. Specific examples are applied herein to illustrate the principle and implementation of the invention. The above embodiments are only used to help understand the method of the invention and its core ideas. The changes or deformations made by those skilled in the art based on the ideas of the invention and the specific implementation and application scope of the invention are within the scope of protection of the invention. To sum up, the content of this specification should not be construed as a limitation of the invention.

What is claimed is:

1. A method for processing data using an adder, the adder comprising a first preprocessing unit and an encoding unit, and the method comprising:
preprocessing first data to obtain a first preprocessing result corresponding to the first data by the first preprocessing unit in response to a summation instruction for the first data; and
outputting a first encoded value to the encoding unit from the first preprocessing unit based on characteristics of the first data;
wherein preprocessing the first data by the first preprocessing unit comprises performing a NOT operation on the first data or outputting the first data directly; and
the first encoded value is 0 or 1.

2. The method according to claim 1, wherein the adder further comprises a second preprocessing unit, and the method further comprises:
preprocessing second data to obtain a second preprocessing result corresponding to the second data by the second preprocessing unit in response to a summation instruction for the second data; and
outputting a second encoded value to the encoding unit from the second preprocessing unit based on characteristics of the second data.

3. The method according to claim 2, wherein the adder further comprises a summation unit, and the method further comprises:
outputting the first encoded value and the second encoded value to the summation unit from the encoding unit; and
summing the first preprocessing result, the second preprocessing result, the first encoded value and the second encoded value by the summation unit.

4. The method according to claim 2, wherein the adder further comprises a summation unit, and the method further comprises:
summing the first encoded value and the second encoded value by the encoding unit to obtain an encoded sum, and sending the encoded sum to the summation unit; and
summing the first preprocessing result, the second preprocessing result and the encoded sum by the summation unit.

5. The method according to claim 1, wherein outputting the first encoded value to the encoding unit from the first preprocessing unit based on characteristics of the first data comprises:
outputting the first encoded value being 1 to the encoding unit from the first preprocessing unit in response to the first data being stored in two's complement and a subtraction operation being performed on the first data; and
outputting the first encoded value being 0 to the encoding unit from the first preprocessing unit in response to the first data being stored in two's complement and an addition operation being performed on the first data.

6. The method according to claim 1, wherein outputting the first encoded value to the encoding unit from the first preprocessing unit based on characteristics of the first data comprises:
outputting the first encoded value being 1 to the encoding unit from the first preprocessing unit in response to the first data being stored in sign-magnitude form as a positive number and a subtraction operation being performed on the first data;
outputting the first encoded value being 0 to the encoding unit from the first preprocessing unit in response to the first data being stored in sign-magnitude form as a positive number and an addition operation being performed on the first data;
outputting the first encoded value being 1 to the encoding unit from the first preprocessing unit in response to the first data being stored in sign-magnitude form as a negative number and an addition operation being performed on the first data; and
outputting the first encoded value being 0 to the encoding unit from the first preprocessing unit in response to the first data being stored in sign-magnitude form as a negative number and a subtraction operation being performed on the first data.

7. The method according to claim 1, wherein preprocessing first data by the first preprocessing unit comprises:
performing a NOT operation on the first data by the first preprocessing unit, in response to:
the first data being stored in two's complement and a subtraction operation being performed on the first data,
the first data being stored in sign-magnitude form as a positive number and a subtraction operation being performed on the first data, or
the first data being stored in sign-magnitude form as a negative number and an addition operation being performed on the first data; and
otherwise, outputting the first data from the first preprocessing unit directly.

8. The method according to claim 3, wherein the summation unit comprises a Wallace adder tree unit.

9. The method according to claim 4, wherein the summation unit comprises a Wallace adder tree unit.

10. An electronic device, comprising:
a processor; and
a memory storing a computer program which, when executed by the processor, causes the processor to implement the method according to claim 1.

11. A non-transitory computer-readable storage medium having stored thereon computer-readable instructions which, when executed by a processor, cause the processor to implement the method according to claim 1.
